(19) United States
(12) Patent Application Publication
(10) Pub. No.: US 2026/0314861 A1
(43) Pub. Date: Oct. 15, 2026

(54) DISSOLVING DEVICE FOR BEVERAGE ADDITIVE AND BEVERAGE MAKER

(71) Applicant: Tsann Kuen (Zhangzhou) Enterprise Co., Ltd., Zhangzhou (CN)

(72) Inventor: Yangtai HE, Zhangzhou (CN)

(21) Appl. No.: 19/530,659

(22) Filed: Feb. 5, 2026

(30) Foreign Application Priority Data
Apr. 14, 2025 (CN) 202520699359.6

(51) Int. Cl. A47J 19/02

(52) U.S. Cl. CPC A47J 19/02

(57) ABSTRACT

A dissolving device for a beverage additive comprises a container and a solvent supply mechanism. The container is configured to receive the beverage additive, and a liquid outlet of the container is located at a lowest point of the container. The container further comprises a liquid supply port located adjacent to or at the lowest point of the container, and the liquid supply port is connected to the solvent supply mechanism.

### RELATED APPLICATIONS

This application claims priority to Chinese patent application number 202520699359.6, filed on Apr. 14, 2025. Chinese patent application number 202520699359.6 is incorporated herein by reference.

### FIELD OF THE DISCLOSURE

The present disclosure relates to the field of household appliances, specifically to a dissolving device for a beverage additive and a beverage maker.

### BACKGROUND OF THE DISCLOSURE

A lemon juicer is a device specifically designed for making lemon juice beverages. Its basic structure mainly comprises a juicer body and a sugar-dissolving mechanism. The juicer body is a core of the lemon juicer, responsible for extracting juice from the lemons, while the sugar-dissolving mechanism dissolves sugar and mixes the sugar with the lemon juice to create a moderately sweet lemon juice beverage. The juicer body typically comprises a juicing head and a collection space located below the juicing head. The juicing head is a main working part of the lemon juicer, and a design of the juicing head usually comprises a rotating juicing disc or blades for squeezing and extracting juice from the lemons. Below the juicing head is the collection space for collecting the extracted lemon juice. The collection space is usually designed as a container or cup-shaped structure for users to drink from directly or process the lemon juice further. The sugar-dissolving mechanism is another important component of the lemon juicer, and a function of the sugar-dissolving mechanism is to dissolve the sugar and mix the sugar with the lemon juice. The sugar-dissolving mechanism is usually connected to the collection space of the juicer body so that the dissolved sugar flows directly into the collection space to be mixed with the lemon juice. In use, the user places sugar on the sugar-dissolving mechanism, which then dissolves the sugar using hot water or steam to create dissolved sugar water. The dissolved sugar water then flows into the container and mixes with lemon juice to create a moderately sweet lemon juice beverage.

While existing lemon juicers offer some convenience in making lemonade, their sugar-dissolving mechanisms still have some shortcomings in practical use, particularly regarding the effectiveness and efficiency of sugar dissolution. In existing sugar-dissolving mechanisms, hot water typically flows out from outlet pipes on a periphery of a mixing chamber. Although this design can dissolve some sugar, a limited path and manner of hot water flow prevents the complete dissolution of all sugar dispersed within the mixing chamber. Specifically, after flowing out from the periphery, a flow path of the hot water is mainly concentrated at an edge of the mixing chamber, while the sugar in a central area is difficult to dissolve sufficiently. This results in low sugar dissolution efficiency, with some sugar remaining undissolved in the mixing chamber, thus affecting production of lemonade and causing material waste.

### BRIEF SUMMARY OF THE DISCLOSURE

The technical problem to be solved by the present disclosure is to provide a dissolving device for a beverage additive and a beverage maker.

In order to solve the above technical problems, the present disclosure provides a dissolving device for a beverage additive comprising a container and a solvent supply mechanism. The container is configured to receive the beverage additive, and a liquid outlet of the container is located at a lowest point of the container. The container further comprises a liquid supply port located adjacent to or at the lowest point of the container, and the liquid supply port is connected to the solvent supply mechanism.

In a preferred embodiment, the liquid supply port is located adjacent to the liquid outlet, and the liquid supply port faces the liquid outlet.

In a preferred embodiment, a bottom wall of the container is inclined, and the liquid outlet is formed at a lowest point of the bottom wall. The container further comprises a liquid passage disposed on the bottom wall, and the liquid passage is connected the liquid supply port and the solvent supply mechanism.

In a preferred embodiment, the bottom wall of the container comprises a liquid passing port protruding upwardly, and the container further comprises a liquid guide cover. The liquid guide cover covers the liquid passing port, and the liquid passage is formed between the liquid guide cover and the bottom wall of the container. The liquid passage is connected to the liquid passing port and the liquid supply port.

In a preferred embodiment, the liquid guide cover comprises a cover body and a cover wall, and the cover body covers the liquid passing port. The cover wall extends from the cover body toward the liquid outlet, and an end of the cover wall adjacent to the liquid outlet forms the liquid supply port. A gap is formed between the cover wall and the bottom wall of the container to form the liquid passage.

In a preferred embodiment, the bottom wall of the container forms a groove, and the cover wall forms a surrounding block. A recessed area is formed between the surrounding block and is recessed in a direction away from the bottom wall. A first end of the recessed area is connected to the cover body, and a second end of the recessed area forms the liquid supply port. The surrounding block is configured to be disposed in the groove so that the liquid passage is formed between the recessed area and the bottom wall of the container.

In a preferred embodiment, the cover wall comprises a plurality of positioning holes, and the plurality of positioning holes are spaced apart from each other and located on an outside of the recessed area. The bottom wall of the container comprises a plurality of positioning posts, and the plurality of positioning posts are spaced apart from each other and disposed on an outside of the groove. The plurality of positioning posts are configured to be positioned and disposed in the plurality of positioning holes.

The present disclosure further provides a beverage maker, and the beverage maker comprises the dissolving device for the beverage additive and a beverage making mechanism. The liquid outlet of the container is connected to the beverage making mechanism.

In a preferred embodiment, the beverage additive is sugar, and the solvent supply mechanism is configured to supply at least one of steam or hot water.

In a preferred embodiment, the beverage making mechanism is a juicing mechanism, and the juicing mechanism comprises a juicing head and a liquid receiving space located below the juicing head. The liquid receiving space comprises a liquid guiding channel, and the liquid guiding channel comprises a first height position and a second height position. The first height position is higher than the second height position. The first height position is connected to the liquid outlet, and the second height position is provided with a beverage outlet.

In a preferred embodiment, the beverage maker comprises a liquid receiving container. The liquid receiving container is disposed below the beverage making mechanism, and the beverage outlet is disposed with a switch valve. When the liquid receiving container is placed below the beverage making mechanism, the liquid receiving container abuts and opens the switch valve to open the beverage outlet.

Compared with the existing techniques, the technical solution has the following advantages.
1. The liquid supply port is adjacent to the liquid outlet, ensuring that the sugar dissolves from a bottommost portion of the sugar. Undissolved sugar will continuously accumulate at the lowest point of the container until the undissolved sugar is completely dissolved, improving dissolution efficiency and avoiding sugar waste. The container can be used to add sugar or other beverage additives. In conjunction with the solvent supply mechanism, a variety of beverages can be made to meet the needs of different users.
2. The liquid passage guides a solvent flow in a directional manner to avoid blockage and ensure that the hot water flows smoothly to the liquid supply port.
3. The liquid guide cover forms the liquid passage with the bottom wall of the container. A modular design facilitates disassembly and cleaning, ensuring equipment hygiene and extending service life.
4. The liquid guiding channel in the liquid receiving space is designed with a height difference to promote full mixing of sugar water and fruit juice, thereby improving the consistency of a taste of a beverage.

### BRIEF DESCRIPTION OF THE DRAWINGS

FIG. 1 is a perspective view of a beverage maker in a preferred embodiment of the present disclosure.

FIG. 2 is a perspective view of a container in the preferred embodiment of the present disclosure.

FIG. 3 is a cross-sectional view of the beverage maker in the preferred embodiment of the present disclosure.

FIG. 4 is a partially enlarged view of a portion of FIG. 3.

FIG. 5 is a perspective view of a juicing head in the preferred embodiment of the present disclosure.

FIG. 6 is a perspective view of a liquid receiving space, a liquid guiding cover, and a bottom wall of a container in the preferred embodiment of the present disclosure.

### DETAILED DESCRIPTION OF THE EMBODIMENTS

The present disclosure will be further described below with reference to the accompanying drawings and specific embodiments.

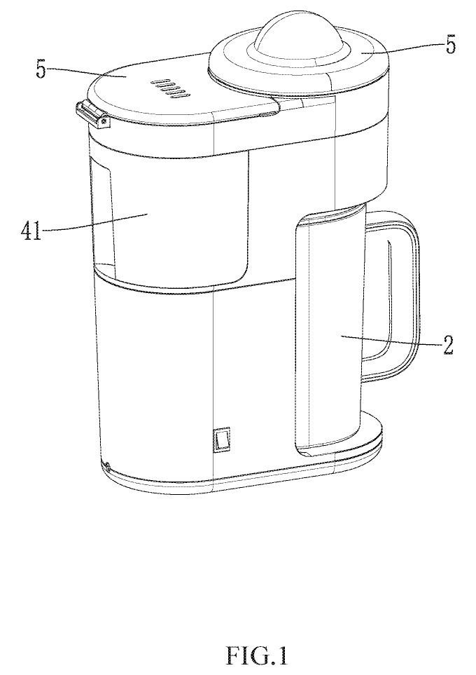

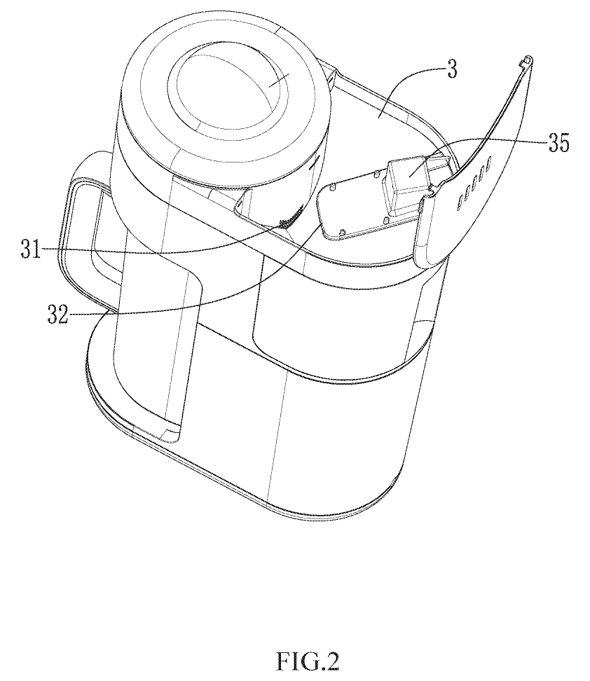

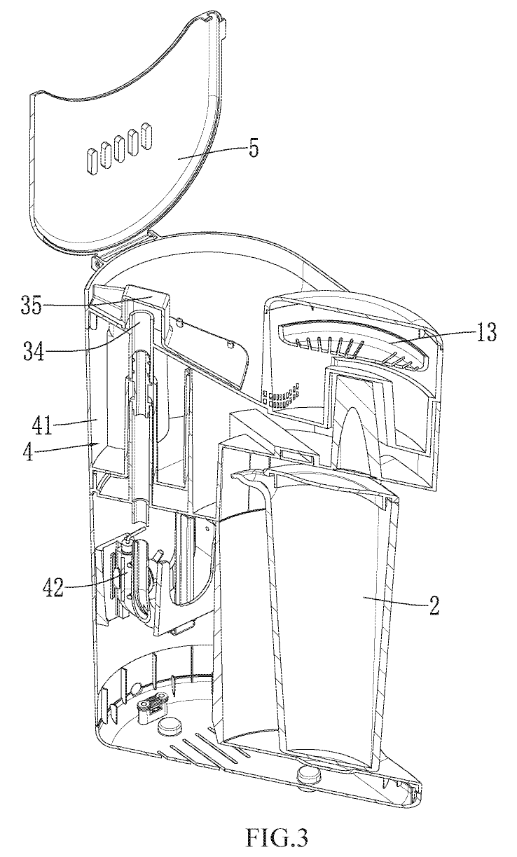

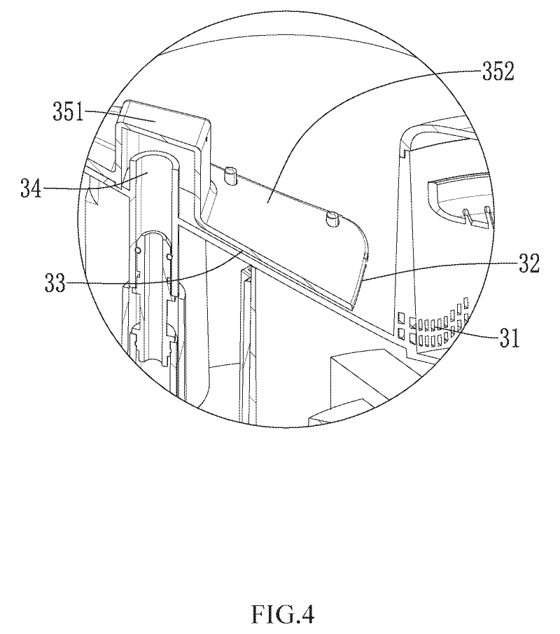

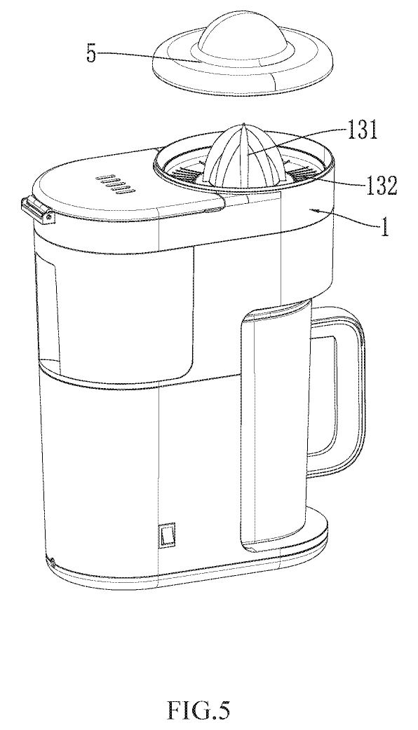

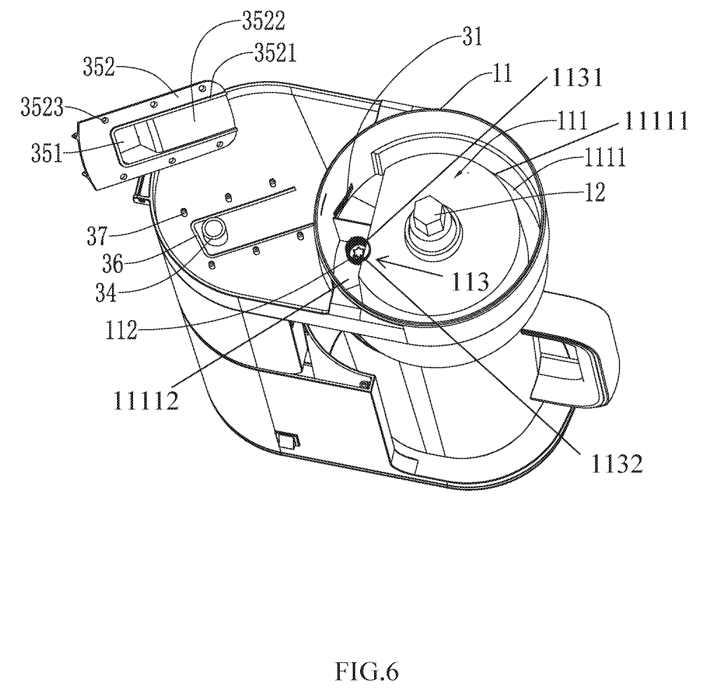

Referring to FIGS. 1-6, a beverage maker is disclosed, and the beverage maker comprises a body and a dissolving device. The body comprises a beverage making mechanism 1 and a liquid receiving container 2. The beverage making mechanism 1 comprises a housing 11, a drive motor 12, and a juicing head 13. A liquid receiving space 111 is formed on an upper portion of the housing 11. The juicing head 13 is rotatably disposed above the liquid receiving space 111, and the drive motor 12 drives the juicing head 13 to rotate. The juicing head 13 comprises a central protrusion 131 and a filter 132. The central protrusion 131 of the juicing head 13 is conical or hemispherical, and the filter 132 is located around the central protrusion 131. A halved lemon can be pressed onto the central protrusion 131, and a rotation of the central protrusion 131 causes a pulp to be squeezed out to extract lemon juice. The lemon juice enters the liquid receiving space 111 through the filter 132. A combination design of the central protrusion 131 and the filter 132 enables efficient juicing. The filter 132 effectively separates the pulp and the lemon juice, improving purity of the lemon juice.

The liquid receiving container 2 is located below the liquid receiving space 111, and the liquid receiving container 2 is configured to receive the lemon juice. In this embodiment, a beverage outlet 112 is defined at a lowest position of the liquid receiving space 111, and a switch valve 113 is disposed on the beverage outlet 112. The liquid receiving container 2 can abut and open the switch valve 113, allowing the lemon juice in the liquid receiving space 111 to flow into the liquid receiving container 2. The linkage design between the switch valve 113 and the liquid receiving container 2 simplifies an operation process, avoids juice leakage, and improves a user experience. The switch valve 113 comprises an elastic element 1131 and a movable valve 1132. When the liquid receiving container 2 is pushed up to press the movable valve 1132 and compress the elastic element 1131, the movable valve 1132 leaves the beverage outlet 112 to form a channel. After the liquid receiving container 2 is removed, the elastic element 1131 rebounds, causing the movable valve 1132 to close the channel.

The dissolving device comprises a container 3 and a solvent supply mechanism 4. In this embodiment, the container 3 is formed on the housing 11 and positioned adjacent to the juicing head 13. A bottom wall of the container 3 is inclined, and a liquid outlet 31 is located at a lowest point of the container 3, which is connected to the liquid receiving space 111. The container 3 is configured to receive a beverage additive, which may be sugar. The container 3 further comprises a liquid supply port 32 located adjacent to or at the lowest point of the container 3, and the liquid supply port 32 is connected to the solvent supply mechanism 4. In this embodiment, the solvent supply mechanism 4 is configured to supply at least one of hot water or steam. During use, a user can add the sugar to the container 3, and the solvent supply mechanism 4 supplies the at least one of hot water or steam to the liquid supply port 32. A lowest portion of the sugar dissolves first to form sugar water, and the sugar water enters the liquid outlet 31 and then the liquid receiving space 111. Undissolved sugar continuously accumulates at the lowest point of the container 3 until all the sugar in the container 3 is dissolved. The inclined bottom wall and a position of the liquid supply port 32 optimize dissolution efficiency and ensure complete utilization of the sugar. In this embodiment, a lid 5 is provided above the container 3 and the juicing head 13 to prevent contamination.

In this embodiment, the liquid supply port 32 is located adjacent to the liquid outlet 31, and the liquid supply port 32 faces the liquid outlet 31. The liquid outlet 31 is formed at the lowest point of the bottom wall of the container 3, and the container 3 further comprises a liquid passage 33 disposed on the bottom wall. The liquid passage 33 is connected to the liquid supply port 32 and the solvent supply mechanism 4.

The bottom wall of the container 3 comprises a liquid passing port 34 protruding upwardly. The container 3 further comprises a liquid guide cover 35, and the liquid guide cover 35 covers the liquid passing port 34. The liquid passage 33 is formed between the liquid guide cover 35 and the bottom wall of the container 3, and the liquid passage 33 is connected to the liquid passing port 34 and the liquid supply port 32. The liquid guide cover 35 comprises a cover body 351 and a cover wall 352. The cover body 351 covers the liquid passing port 34, and the cover wall 352 extends from the cover body 351 toward the liquid outlet 31. An end of the cover wall 352 adjacent to the liquid outlet 31 forms the liquid supply port 32. A gap is formed between the cover wall 352 and the bottom wall of the container 3 to form the liquid passage 33. The bottom wall of the container 3 forms a groove 36, and the cover wall 352 forms a surrounding block 3521. A recessed area 3522 is formed between the surrounding block 3521 in a direction away from the bottom wall of the container 3. A first end of the recessed area 3522 is connected to the cover body 351, and a second end of the recessed area 3522 forms the liquid supply port 32. The surrounding block 3521 is configured to be inserted into the groove 36, so that the liquid passage 33 is formed between the recessed area 3522 and the bottom wall of the container 3. The cover wall 352 comprises a plurality of positioning holes 3523, and the plurality of positioning holes 3523 are spaced apart from each other and located on an outside of the recessed area 3522. The bottom wall of the container 3 comprises a plurality of positioning posts 37, and the plurality of positioning posts 37 are spaced apart from each other and disposed on an outside of the groove 36. The plurality of positioning posts 37 can be positioned and inserted into the plurality of positioning holes 3523. The liquid guide cover 35 is designed for easy cleaning and maintenance, and the liquid passage 33 guides a solvent flow in a directional manner to avoid clogging. It is understood that a positioning structure is not limited to this, and other structures that can achieve a same function can be used as alternatives, such as setting the plurality of positioning posts 37 on the cover wall 352 and setting the plurality of positioning holes 3523 on the bottom wall of the container 3.

In this embodiment, the liquid receiving space 111 comprises a liquid guiding channel 1111, and the liquid guiding channel 1111 has a first height position 11111 and a second height position 11112. The first height position 11111 is higher than the second height position 11112. The first height position 11111 is connected to the liquid outlet 31, and the second height position 11112 is provided with the beverage outlet 112. When the liquid receiving container 2 is disposed below the beverage making mechanism 1, the liquid receiving container 2 abuts and opens the switch valve 113 to open the beverage outlet 112. A height difference design of the liquid guiding channel 1111 promotes thorough mixing of sugar water and fruit juice, improving consistency of a taste of a beverage.

In this embodiment, for the solvent supply mechanism 4, a water tank 41 is disposed below the container 3, and an instant heating pipe 42 is provided below the water tank 41. The water tank 41 is connected to an inlet of the instant heating pipe 42, and an outlet of the instant heating pipe 42 is connected to the liquid passing port 34. Water in the water tank 41 is heated by the instant heating pipe 42 to form the hot water or the steam, and then the hot water or the steam flows to the liquid passing port 34.

During use, the user presses the halved lemon onto the central protrusion 131 of the juicing head 13 and adds an appropriate amount of sugar or other beverage additives to the container 3. The drive motor 12 is started, and the juicing head 13 begins to rotate. The central protrusion 131 presses the pulp of the halved lemon, and extracted juice flows through the filter 132 into the liquid receiving space 111. The solvent supply mechanism 4 supplies the at least one of hot water or steam to the liquid supply port 32 of the container 3, causing the sugar to gradually dissolve in the container 3, forming the sugar water. The undissolved sugar continuously accumulates at the lowest point of the container 3 until the undissolved sugar is completely dissolved. The sugar water flows into the liquid receiving space 111 through the liquid outlet 31, and the sugar water is mixed with the lemon juice. The liquid guiding channel 1111 of the liquid receiving space 111 guides mixed liquid from the first height position 11111 to the second height position 11112. The user places the liquid receiving container 2 below the beverage making mechanism 1, and the liquid receiving container 2 abuts and opens the switch valve 113. The mixed liquid flows into the liquid receiving container 2 through the beverage outlet 112. Ice cubes can be pre-placed in the liquid receiving container 2 to complete beverage preparation. After use, the user can remove the liquid guide cover 35 and clean the container 3 and the liquid receiving space 111 to ensure hygiene of equipment and extend a service life of the beverage maker.

The above description is only a preferred embodiment of the present disclosure, but a design concept of the present disclosure is not limited thereto. Any non-substantial modifications made to the present disclosure by those skilled in the art within the scope of the technology disclosed in the present disclosure using this concept shall be deemed as an infringement of the protection scope of the present disclosure.

What is claimed is:

1. A dissolving device for a beverage additive, comprising:
a container, and
a solvent supply mechanism, wherein:
the container is configured to receive the beverage additive,
a liquid outlet of the container is located at a lowest point of the container,
the container further comprises a liquid supply port located adjacent to or at the lowest point of the container, and
the liquid supply port is connected to the solvent supply mechanism.

2. The dissolving device for the beverage additive according to claim 1, wherein:
the liquid supply port is located adjacent to the liquid outlet, and
the liquid supply port faces the liquid outlet.

3. The dissolving device for the beverage additive according to claim 1, wherein:
a bottom wall of the container is inclined,
the liquid outlet is formed at a lowest point of the bottom wall,
the container further comprises a liquid passage disposed on the bottom wall, and
the liquid passage is connected the liquid supply port and the solvent supply mechanism.

4. The dissolving device for the beverage additive according to claim 3, wherein:
the bottom wall of the container comprises a liquid passing port protruding upwardly,
the container further comprises a liquid guide cover,
the liquid guide cover covers the liquid passing port,
the liquid passage is formed between the liquid guide cover and the bottom wall of the container, and
the liquid passage is connected to the liquid passing port and the liquid supply port.

5. The dissolving device for the beverage additive according to claim 4, wherein:
the liquid guide cover comprises a cover body and a cover wall,
the cover body covers the liquid passing port,
the cover wall extends from the cover body toward the liquid outlet,
an end of the cover wall adjacent to the liquid outlet forms the liquid supply port, and
a gap is formed between the cover wall and the bottom wall of the container to form the liquid passage.

6. The dissolving device for the beverage additive according to claim 5, wherein:
the bottom wall of the container forms a groove,
the cover wall forms a surrounding block,
a recessed area is formed between the surrounding block and is recessed in a direction away from the bottom wall,
a first end of the recessed area is connected to the cover body,
a second end of the recessed area forms the liquid supply port, and
the surrounding block is configured to be disposed in the groove so that the liquid passage is formed between the recessed area and the bottom wall of the container.

7. The dissolving device for the beverage additive according to claim 6, wherein:
the cover wall comprises a plurality of positioning holes,
the plurality of positioning holes are spaced apart from each other and located on an outside of the recessed area,
the bottom wall of the container comprises a plurality of positioning posts,
the plurality of positioning posts are spaced apart from each other and disposed on an outside of the groove, and
the plurality of positioning posts are configured to be positioned and disposed in the plurality of positioning holes.

8. A beverage maker, comprising:
the dissolving device for the beverage additive according to claim 1, and
a beverage making mechanism, wherein:
the liquid outlet of the container is connected to the beverage making mechanism.

9. The beverage maker according to claim 8, wherein:
the beverage additive is sugar, and
the solvent supply mechanism is configured to supply at least one of steam or hot water.

10. The beverage maker according to claim 9, wherein:
the beverage making mechanism is a juicing mechanism,
the juicing mechanism comprises a juicing head and a liquid receiving space located below the juicing head,
the liquid receiving space comprises a liquid guiding channel,
the liquid guiding channel comprises a first height position and a second height position,
the first height position is higher than the second height position, and
the first height position is connected to the liquid outlet, and the second height position is provided with a beverage outlet.

11. The beverage maker according to claim 10, comprising:
a liquid receiving container, wherein:
the liquid receiving container is disposed below the beverage making mechanism,
the beverage outlet is disposed with a switch valve, and
when the liquid receiving container is placed below the beverage making mechanism, the liquid receiving container abuts and opens the switch valve to open the beverage outlet.

12. The dissolving device for the beverage additive according to claim 2, wherein:
a bottom wall of the container is inclined,
the liquid outlet is formed at a lowest point of the bottom wall,
the container further comprises a liquid passage disposed on the bottom wall, and
the liquid passage is connected the liquid supply port and the solvent supply mechanism.

13. The dissolving device for the beverage additive according to claim 12, wherein:
the bottom wall of the container comprises a liquid passing port protruding upwardly,
the container further comprises a liquid guide cover,
the liquid guide cover covers the liquid passing port,
the liquid passage is formed between the liquid guide cover and the bottom wall of the container, and
the liquid passage is connected to the liquid passing port and the liquid supply port.

14. The dissolving device for the beverage additive according to claim 13, wherein:
the liquid guide cover comprises a cover body and a cover wall,
the cover body covers the liquid passing port,
the cover wall extends from the cover body toward the liquid outlet,
an end of the cover wall adjacent to the liquid outlet forms the liquid supply port, and
a gap is formed between the cover wall and the bottom wall of the container to form the liquid passage.

15. The dissolving device for the beverage additive according to claim 14, wherein:
the bottom wall of the container forms a groove,
the cover wall forms a surrounding block,
a recessed area is formed between the surrounding block and is recessed in a direction away from the bottom wall,
a first end of the recessed area is connected to the cover body,
a second end of the recessed area forms the liquid supply port, and
the surrounding block is configured to be disposed in the groove so that the liquid passage is formed between the recessed area and the bottom wall of the container.

16. The dissolving device for the beverage additive according to claim 15, wherein:
the cover wall comprises a plurality of positioning holes,
the plurality of positioning holes are spaced apart from each other and located on an outside of the recessed area,
the bottom wall of the container comprises a plurality of positioning posts,
the plurality of positioning posts are spaced apart from each other and disposed on an outside of the groove, and
the plurality of positioning posts are configured to be positioned and disposed in the plurality of positioning holes.
